(19) United States
(12) Patent Application Publication
(10) Pub. No.: US 2008/0056836 A1
(43) Pub. Date: Mar. 6, 2008

(54) EDGED CLAMPING DEVICE FOR CLAMPING A DRILL BIT

(76) Inventor: Hsuan-Sen Shiao, Taichung Hsien (TW)

Correspondence Address: SHERIDAN ROSS PC, 1560 BROADWAY, SUITE 1200, DENVER, CO, 80202, US

(21) Appl. No.: 11/468,653

(22) Filed: Aug. 30, 2006

(51) Int. Cl. B23B 51/00

(52) U.S. Cl. 408/191

(57) ABSTRACT

An edged clamping device for clamping a drill bit includes: a housing including a middle section that defines a jaw-receiving space therein and that has upper and lower ends, the housing further including a cylindrical section that has a connecting portion extending from the middle section and a tapered end portion, and a cap formed with a threaded hole, the cylindrical section being formed with a notch defined by an edged wall which extends through the tapered end portion and into the connecting portion; a plurality of spring-biased jaws disposed in the jaw-receiving space, defining a clamping channel thereamong, and movable relative to the housing so as to permit adjustment of a diameter of the clamping channel; and a hollow driving rod extending threadedly through the threaded hole in the cap into the housing to abut against the jaws so as to permit adjustment of the diameter of the clamping channel.

### BACKGROUND OF THE INVENTION

1. Field of the Invention

The invention relates to an edged clamping device, more particularly to an edged clamping device having movable jaws for clamping a drill bit thereamong.

2. Description of the Related Art

As shown in FIGS. 1 and 2, a conventional edged clamping device 10 is shown to be adapted to be mounted on an electric drilling device 11 or a pneumatic drilling device (not shown) and is adapted to clamp a drill bit 12.

The edged clamping device 10 includes a tubular housing 13 defining an axis, and a fastener 14.

The housing 13 includes an outer surrounding wall 131 confining an axially extending through-hole 132 and formed with a radially extending fastener hole 133 in spatial communication with the through-hole 132, a reamer part 134, and a coupling part 135 for coupling to the electric drilling device 11. The reamer part 134 has an edge 136 serving as a blade for reaming a cone-shaped recess 16 at a top end of a drilled hole, and is formed with a shaving-discharging groove 137. The fastener 14 extends threadedly through the fastener hole 133 for fastening the drill bit 12 extended into the through-hole 132.

In use, the drill bit 12 is extended into the through-hole 132, followed by tightening the fastener 14 until the drill bit 12 is firmly clamped in the edged clamping device 10.

The conventional edged clamping device 10 is disadvantageous in that mounting of the drill bit 12 on the edged clamping device 10 is relatively inconvenient, and the depth of the recess 16 (see FIG. 2) reamed by the reamer part 134 is difficult to control (the drawing on the right-hand side of FIG. 2 shows that the depth of the recess 16 can be easily over-reamed).

### SUMMARY OF THE INVENTION

Therefore, the object of the present invention is to provide an edged clamping device for clamping a drill bit that can overcome the aforesaid drawbacks associated with the prior art.

Accordingly, an edged clamping device for clamping a drill bit of the present invention comprises: a housing including a middle section that defines a jaw-receiving space therein and that has upper and lower ends, the housing further including a cylindrical section that has a connecting portion extending downwardly from the lower end of the middle section, and a tapered end portion that is tapered from the connecting portion, the cylindrical section being formed with a notch defined by an edged wall which serves as a blade and which extends through the tapered end portion and into the connecting portion of the cylindrical section, the housing further including an upper section extending upwardly from the upper end of the middle section and having a top open end, and a cap mounted on the top open end of the upper section and formed with a threaded hole; a plurality of spring-biased jaws disposed in the jaw-receiving space, defining a clamping channel thereamong, and movable relative to the housing so as to adjust a diameter of the clamping channel for clamping a drill bit extending therethrough; and a hollow driving rod extending threadedly through the threaded hole in the cap into the housing to abut against the jaws so as to permit adjustment of the diameter of the clamping channel.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded view of a conventional edged clamping device for clamping a drill bit;

FIG. 2 is a schematic view to illustrate difficulty in controlling the depth of a recess reamed by the conventional edged claming device;

FIG. 3 is a schematic view of the first preferred embodiment of an edged clamping device for clamping a drill bit according to the present invention;

FIG. 4 is a schematic sectional view to illustrate how the first preferred embodiment is operated to clamp the drill bit;

FIG. 5 is a sectional view taken along line V-V in FIG. 4;

FIG. 6 is an exploded view of the second preferred embodiment of the edged clamping device according to this invention;

FIGS. 7 and 8 are schematic views to illustrate how the second preferred embodiment can be operated to control the depth of a recess during drilling of a screw hole in a workpiece; and

FIG. 9 is a sectional view of the third preferred embodiment of the edged clamping device according to this invention.

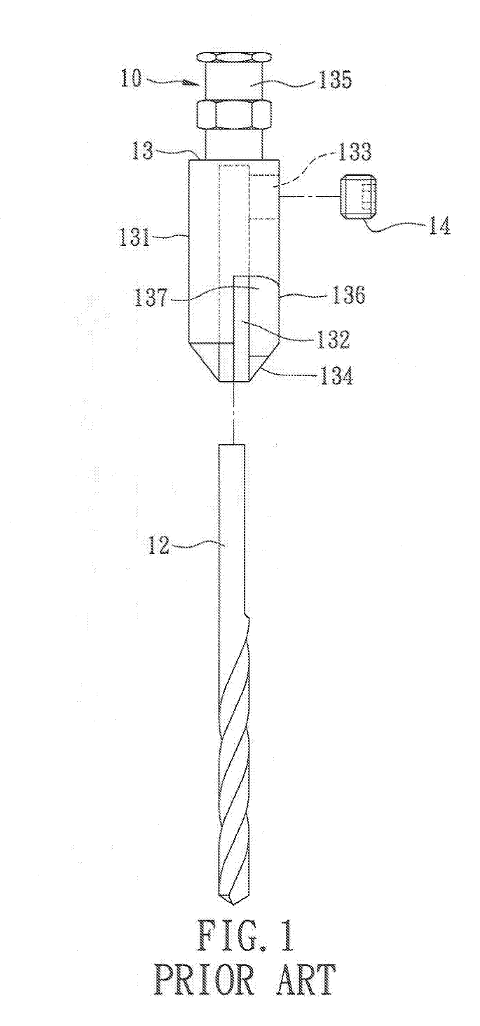

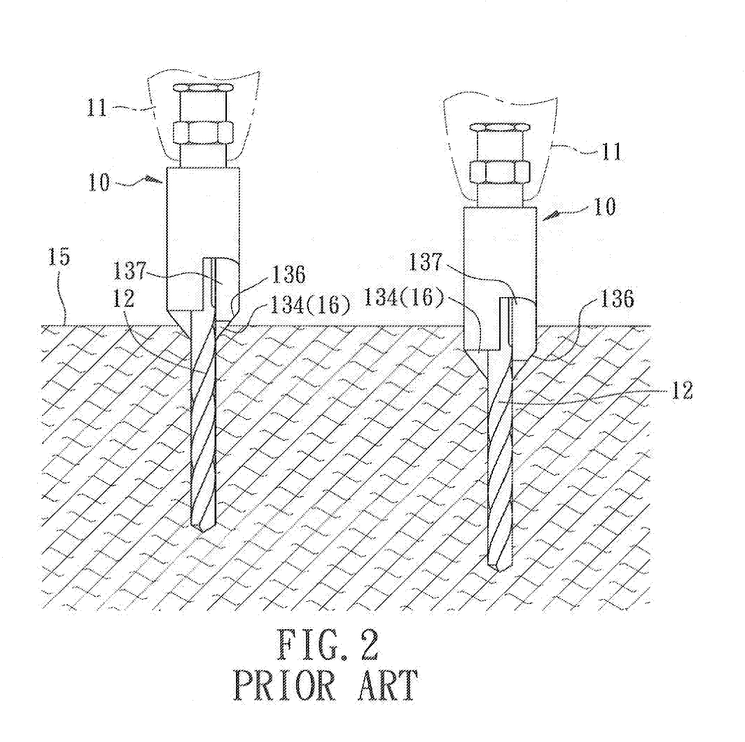

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

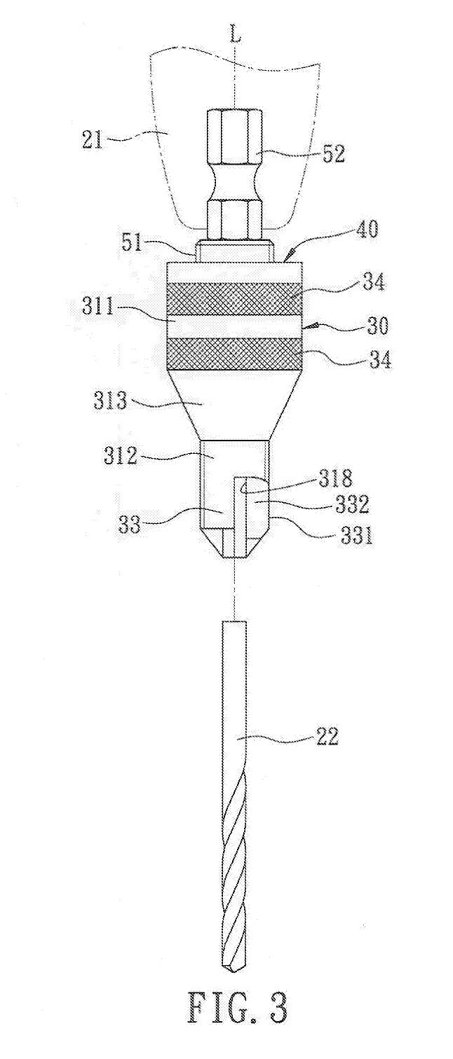

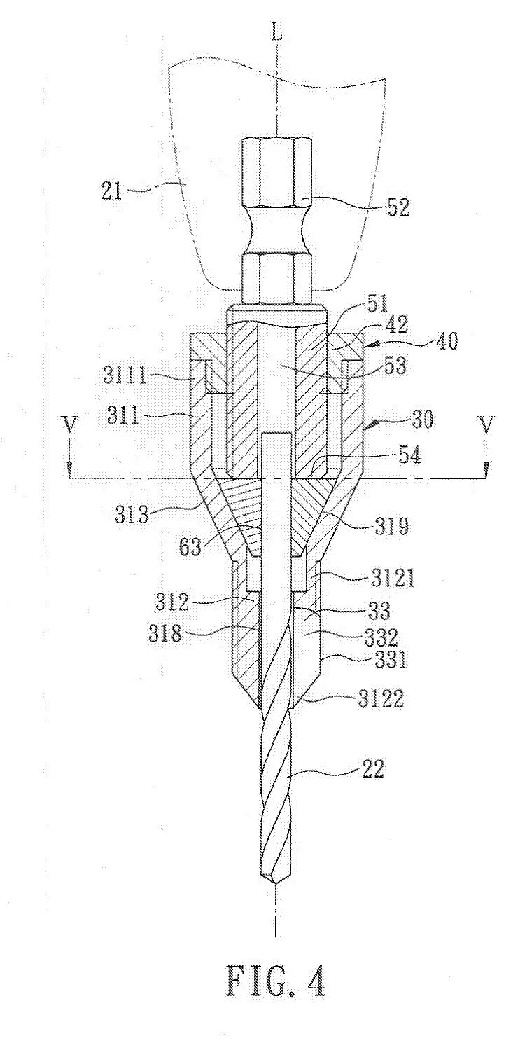

As shown in FIGS. 3 to 5, the first preferred embodiment of an edged clamping device for clamping a drill bit 22 according to the present invention is shown to include: a housing 30 defining an axis (L) and including a middle section 313 that defines a jaw-receiving space 319 therein, that has upper and lower ends, and that is tapered from the upper end to the lower end, the housing 30 further including a cylindrical section 312 that has a connecting portion 3121 extending downwardly from the lower end of the middle section 313, and a tapered end portion 3122 that is tapered from the connecting portion 3121, the cylindrical section 312 being formed with a notch 33 defined by an edged wall 331 which serves as a blade and which extends through the tapered end portion 3122 and into the connecting portion 3121 of the cylindrical section 312; and a plurality of spring-biased jaws 61 disposed in the jaw-receiving space 319, defining a clamping channel 63 thereamong, and movable relative to the housing 30 so as to permit adjustment of a diameter of the clamping channel 63 for clamping a drill bit 22 extending therethrough. The cylindrical section 312 defines a bit-extension hole 318 for extension of the drill bit 22 therethrough and into the clamping channel 63.

In this embodiment, the housing 30 further includes an upper section 311 extending upwardly from the upper end of the middle section 313 and having a top open end 3111, and a cap 40 mounted threadedly on the top open end 3111 of the upper section 311 and formed with a threaded hole 42. The edged clamping device further includes a hollow driving rod 51 extending threadedly through the threaded hole 42 in the cap 40 into the housing 30 to abut against the jaws 61 so as to permit adjustment of the diameter of the clamping channel 63 by axial movement of the driving rod 51 which results in sliding movement of the jaws 61 along a conical inner surface of the middle section 313 of the housing 30.

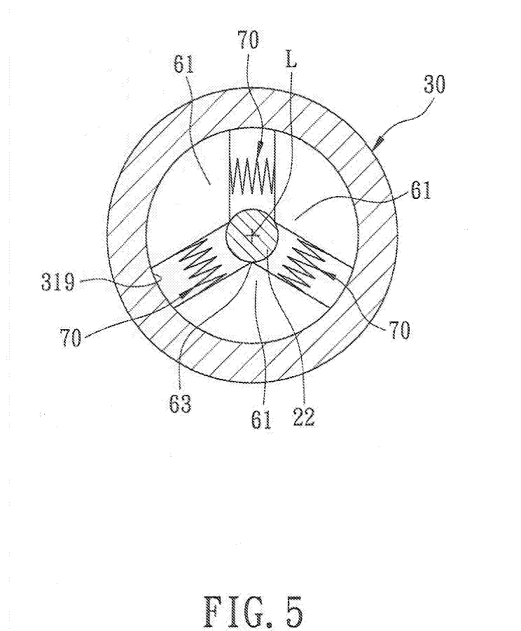

Referring to FIG. 5, the edged clamping device further includes a plurality of urging members 70, each of which is disposed between and abuts against two adjacent ones of the jaws 61 so as to provide an urging force to move the jaws 61 toward the driving rod 51. In this embodiment, the number of the urging members 70 or the jaws 61 is three. However, in practice, there is no limit in the numbers of the urging members 70 and the jaws 6.

The upper section 311 of the housing 30 has an outer surface formed with a plurality of anti-slip strips 34 for facilitating rotation of the housing 30 relative to the cap 40.

A coupling part 52 extends from the driving rod 51, and is adapted to be connected to a drilling device 21. The driving rod 51 defines a bit-receiving hole 53 for extension of the drill bit 22 therein, and has an end face 54 opposite to the coupling part 52 and abutting against the jaws 61.

In use, the drill bit 22 is extended through the bit-extension hole 318 in the cylindrical section 312, the clamping channel 63 among the jaws 61, and into the bit-receiving hole 53 in the driving rod 51. The driving rod 51 is rotated relative to the cap 40 to drive the jaws 61 to move downwardly to clamp tightly the drill bit 22.

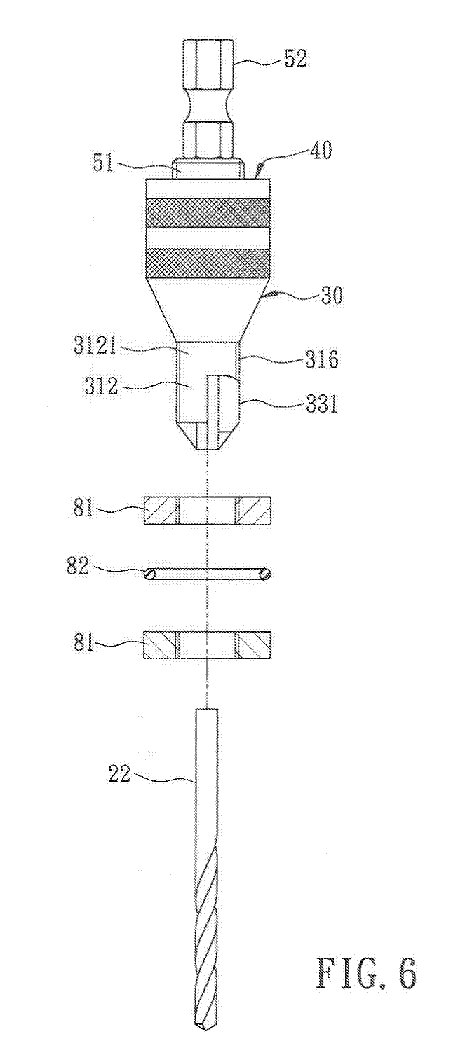

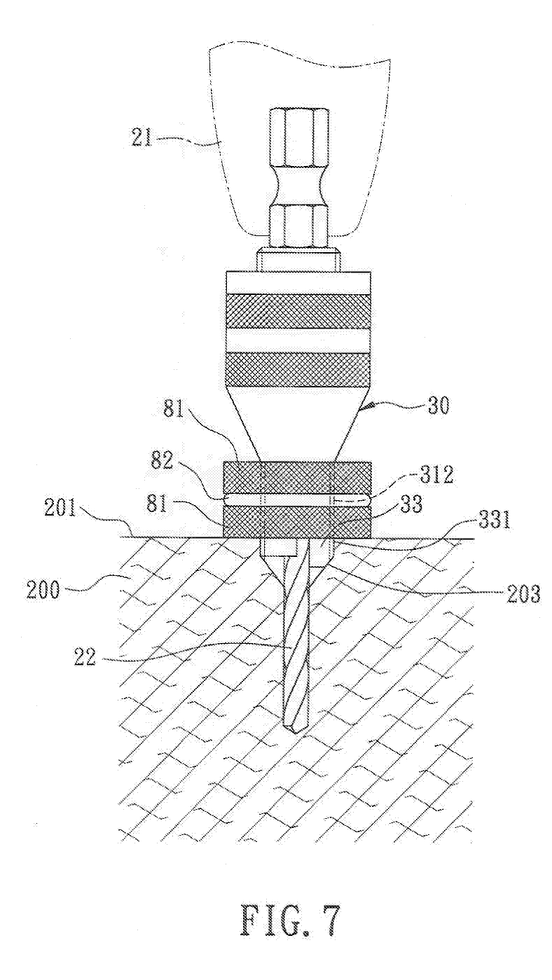

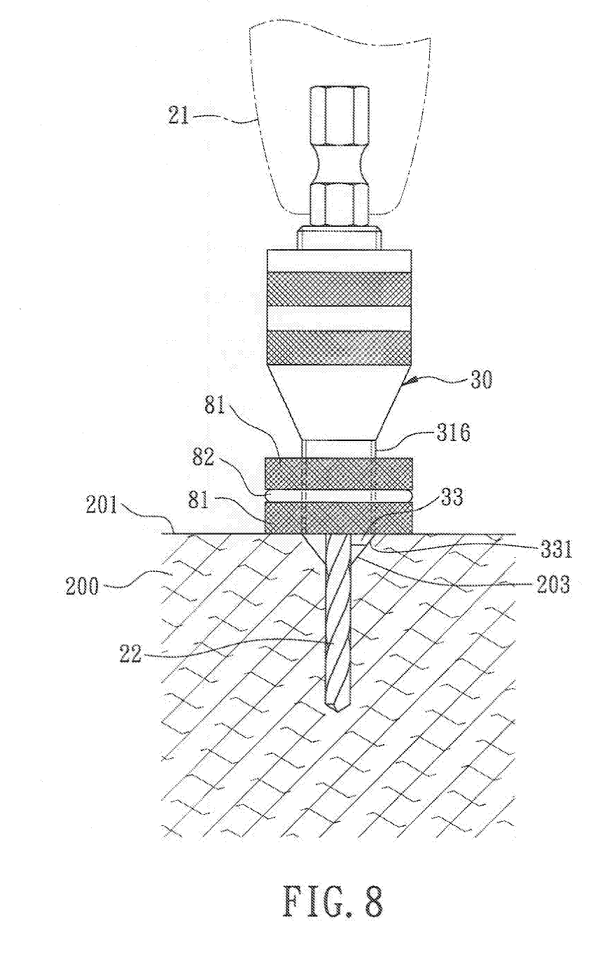

Referring to FIGS. 6, 7 and 8, the second preferred embodiment of this invention differs from the previous embodiment in that the connecting portion 3121 of the cylindrical section 312 of the housing 30 is formed with an outer thread 316. The edged clamping device further includes a pair of screw nuts 81 engaging threadedly the outer thread 316 of the connecting portion 3121 of the cylindrical section 312. In this embodiment, an elastic anti-slip ring 82 is sandwiched between the screw nuts 81 to prevent undesired loosening of each of the screw nuts 81 on the outer thread 316 of the cylindrical section 312 of the housing 30. During a drilling operation, the edged clamping device is rotated by the drilling device 21, which permits the drill bit 22 clamped by the jaws 61 of the edged clamping device to drill a screw hole 202 in a workpiece 200, and which permits the edged wall 331 of the cylindrical section 312 to cut an end periphery of the screw hole 202 to form a recess 203 thereat. The edged wall 331 of the cylindrical section 33 is prevented from cutting further into the workpiece 200 when the lower screw nut 81 abuts against a top surface 201 of the workpiece 200. Hence, with the inclusion of the screw nuts 81 that engage threadedly the cylindrical section 312 of the housing 30, the depth of the recess 203 thus formed can be easily controlled. FIGS. 7 and 8 illustrate how the depth of the recess 203 can be controlled by adjusting the positions of the screw nuts 81 on the outer thread 316 of the cylindrical section 312.

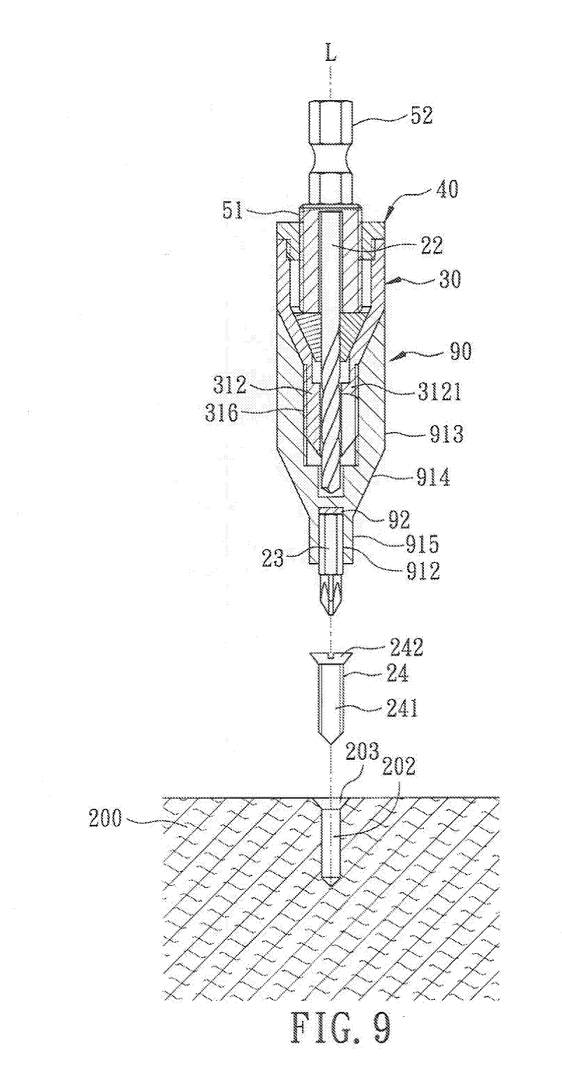

Referring to FIG. 9, the third preferred embodiment of this invention differs from the previous embodiments in that the edged clamping device further includes a bit-holding sleeve 90 having a threaded section 913 engaging threadedly the outer thread 316 of the connecting portion 3121 of the cylindrical section 312 of the housing 30, a tapered section 914 tapered from the threaded section 913, and a cylindrical section 915 extending from the tapered section 914 of the bit-holding sleeve 90 and defining a blind bore 912 adapted to receive a screw driver bit 23 therein. Preferably, the edged clamping device further includes a magnet 92 mounted in an end of the blind bore 912 in the cylindrical section 915 of the bit-holding sleeve 90 for magnetically attracting the screw driver bit 23. With the inclusion of the bit-holding sleeve 90 in the edged clamping device, the edged clamping device can serve as a screw driver for driving a screw 24 into the screw hole 202 in the workpiece 200. The screw 24 has a head 241 that is received in the recess 203 at the top end of the screw hole 202 in the workpiece 200.

With the inclusion of the jaws 61 and the screw nuts 81 in the edged clamping device of this invention, the aforesaid drawbacks associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An edged clamping device for clamping a drill bit, said edged clamping device comprising:
a housing including a middle section that defines a jaw-receiving space therein and that has upper and lower ends, said housing further including a cylindrical section that has a connecting portion extending downwardly from said lower end of said middle section, and a tapered end portion that is tapered from said connecting portion, said cylindrical section being formed with a notch defined by an edged wall which serves as a blade and which extends through said tapered end portion and into said connecting portion of said cylindrical section, said housing further including an upper section extending upwardly from said upper end of said middle section and having a top open end, and a cap mounted on said top open end of said upper section and formed with a threaded hole;
a plurality of spring-biased jaws disposed in said jaw-receiving space, defining a clamping channel thereamong, and movable relative to said housing so as to adjust a diameter of said clamping channel for clamping a drill bit extending therethrough; and
a hollow driving rod extending threadedly through said threaded hole in said cap into said housing to abut against said jaws so as to permit adjustment of the diameter of said clamping channel.

2. The edged clamping device as claimed in claim 1, further comprising a plurality of urging members, each of which is disposed between and abuts against two adjacent ones of said jaws so as to provide an urging force to move said jaws toward said driving rod.

3. The edged clamping device as claimed in claim 1, wherein said connecting portion of said cylindrical section of said housing is formed with an outer thread, said edged clamping device further comprising a pair of screw nuts engaging threadedly said outer thread of said connecting portion of said cylindrical section.

4. The edged clamping device as claimed in claim 3, further comprising an elastic anti-slip ring sandwiched between said screw nuts.

5. The edged clamping device as claimed in claim 1, wherein said upper section of said housing has an outer surface that is formed with an anti-slip strips.

6. The edged clamping device as claimed in claim 1, wherein said driving rod is formed with a bit-receiving hole for extension of the drill bit thereinto.

7. The edged clamping device as claimed in claim 1, wherein said connecting portion of said cylindrical section of said housing is formed with an outer thread, said edged clamping device further comprising a bit-holding sleeve having a threaded section engaging threadedly said outer thread of said connecting portion of said cylindrical section of said housing, a tapered section tapered from said threaded section, and a cylindrical section extending from said tapered section of said bit-holding sleeve and defining a blind bore adapted to receive a screw driver bit.

8. The edged clamping device as claimed in claim 7, further comprising a magnet mounted in said blind bore in said cylindrical section of said bit-holding sleeve.
